(19) United States
(12) Patent Application Publication
(10) Pub. No.: US 2026/0253822 A1
(43) Pub. Date: Aug. 27, 2026

(54) VACUUM INTERRUPTER

(71) Applicant: HYOSUNG HEAVY INDUSTRIES CORPORATION, Seoul (KR)

(72) Inventors: Su Youl WOO, Changwon-si, Gyeongsangnam-do (KR); In Su LEE, Changwon-si, Gyeongsangnam-do (KR); Kwang Ho JEONG, Changwon-si, Gyeongsangnam-do (KR)

(21) Appl. No.: 18/878,087

(22) PCT Filed: Feb. 22, 2023
(86) PCT No.: PCT/KR2023/002513

§ 371 Date: Dec. 23, 2024

(30) Foreign Application Priority Data
Feb. 7, 2023 (KR) 10-2023-0016171

(51) Int. Cl. H01H 33/662; H01H 33/666

(52) U.S. Cl. CPC H01H 33/66207; H01H 33/66238; H01H 33/666; H01H 2033/6623; H01H 2033/66246

(57) ABSTRACT

A vacuum interrupter is disclosed. Specifically, the vacuum interrupter has a sleeve-receiving part installed at an end of a movable rod so that a portion of a sleeve preventing a bellows from buckling can be received in a sleeve-receiving space inside a container when the movable rod performs opening movement.

### TECHNICAL FIELD

The present disclosure relates to a vacuum interrupter and, more particularly, to a vacuum interrupter having a sleeve-receiving part installed at a lower portion of a movable rod, so that a portion of a sleeve preventing buckling of a bellows can be received into a sleeve-receiving space inside a container when the movable rod performs opening movement.

### BACKGROUND ART

In general, a vacuum circuit breaker is a type of circuit breaker installed in a high-voltage power system and configured to protect the power system by interrupting a circuit when a dangerous situation such as a short circuit or an overcurrent occurs. The vacuum circuit breaker is designed to take advantage of excellent insulation performance and arc extinguishing ability in a vacuum state.

For the vacuum circuit breaker, a core component is a vacuum interrupter, which performs the functions of conducting and interrupting the above-described circuit within a sealed vacuum tube. The vacuum interrupter includes a fixed electrode and a movable electrode that can be brought into and separated from the fixed electrode. Specifically, a portion where the fixed electrode and the movable electrode are brought into direct contact with each other is a contact point.

At this point, specifically, since the movable electrode should perform linear movement to be brought into contact with or separated from the fixed electrode while maintaining a vacuum state in the vacuum interrupter, a bellows is installed around the movable electrode.

The inside space of the vacuum interrupter is a vacuum state, and atmospheric pressure or gas pressure is applied to the inside space of the bellows. Since the gas pressure applied to the bellows has a large effect on the operating characteristics of the vacuum interrupter, the effect of gas pressure should be considered when selecting design or capacity during operation.

The bellows may contract and expand to maintain airtightness when the movable electrode is moved vertically and serve to maintain airtightness of the movable electrode.

Furthermore, a guide or a sleeve may be installed inside the bellows to prevent buckling of the bellows when the bellows contracts and expands.

A vacuum interrupter equipped with an existing guide or sleeve was disclosed in Korean Patent No. 10-1502265.

The above-described existing vacuum interrupter is equipped with a guide or a sleeve to prevent buckling of the bellows when the bellows contracts and expands. Since the guide or the sleeve is installed only at some sections of the bellows, when the bellows expands, buckling of some sections of the bellows is not prevented, which is a problem.

Furthermore, when the guide or the sleeve is installed to be long in a longitudinal direction in consideration of the length during the expansion of the bellows, the guide or the sleeve is exposed outward of the vacuum interrupter when the bellows contracts, which is a problem.

### DISCLOSURE

### Technical Problem

Accordingly, the present disclosure has been made keeping in mind the above problems occurring in the related art, and an objective of the present disclosure is to provide a vacuum interrupter in which a sleeve-receiving part is installed at a lower portion of a movable rod and a portion of a sleeve preventing buckling of a bellows can be received into a sleeve-receiving space inside a container when the movable rod performs opening movement.

### Technical Solution

According to the characteristics of the present disclosure for achieving the above-described objective, there is provided a vacuum interrupter according to the present disclosure including: a container made of an insulating material, and having a vacuum therein; a movable seal cup coupled to a first end of the container, having a movable rod through hole on a central portion, and closing a first side of the container; a fixed seal cup coupled to a second end of the container and closing a second side of the container; a movable rod inserted into the movable rod through hole to be movably installed and having a movable contact point at an end portion thereof; a fixed rod provided through the fixed seal cup and having a fixed contact point at an end portion thereof; a bellows shaped in a corrugated tube, provided to cover an external circumferential surface of the movable rod, and configured to perform contraction and expansion in response to movement of the movable rod; a sleeve having a tube shape, provided between the bellows and the movable rod, and guiding the contraction and expansion of the bellows; and a sleeve-receiving part installed at a second end of the movable rod, having a sleeve-receiving space therein, and receiving a portion of the sleeve when the movable rod performs opening movement.

The sleeve-receiving part may have a diameter greater than a diameter of the movable rod, have a tube shape, and have a first end fixed to an end of the bellows and a second end fixed to the second end portion of the movable rod.

The sleeve may include: a sleeve body having a tube shape, provided to cover the movable rod, and having a length corresponding to an expansion length of the bellows; and a sleeve fixing end formed by being bent at an end portion of the sleeve body and fixing the sleeve body to the movable seal cup.

A bushing may be further included at a coupling portion between the sleeve fixing end and the movable seal cup, and the bushing may have a movable rod mounting hole on an outer surface to guide movement of the movable rod and prevent friction between the movable rod and the movable seal cup.

A bushing cover may be provided on the outer surface of the bushing to cover the bushing along an edge of the bushing and fix the bushing to the movable seal cup.

A second end of the bellows may include a bellows protection shield having a cup shape, disposed to be spaced apart from the bellows at a predetermined interval along an outer circumferential surface of the bellows, and preventing damage to the bellows due to arc generated inside the container.

### Advantageous Effects

According to the present disclosure, the vacuum interrupter has the following effects.

According to the present disclosure, a sleeve-receiving part is installed at a lower portion of a movable rod, so that a portion of a sleeve preventing buckling of a bellows can be received into a sleeve-receiving space inside a container when the movable rod performs the opening movement.

Therefore, during the contraction of the bellows, since a lower portion of the sleeve is received in the sleeve-receiving part, there is the advantage of securing the space for the sleeve to be arranged in the container without the need for exposing the sleeve outward of the container.

Furthermore, since the sleeve is operated inside the container without the need for outward exposure of the sleeve preventing buckling of the bellows, design changes and additional components to secure power paths can be minimized, so the manufacturing period can be shortened and manufacturing costs can be reduced.

Furthermore, since the sleeve guides the whole operational section of the bellows, the sleeve can support and guide the entire corrugations of the bellows, so it is possible to fundamentally prevent the reduction in lifespan due to buckling of the bellows.

### DESCRIPTION OF DRAWINGS

FIG. 1 is a sectional view illustrating configuration of a preferred embodiment of a vacuum interrupter according to the present disclosure.

FIG. 2 is a sectional view illustrating a movable rod in opening movement constituting the embodiment of the present disclosure.

FIG. 3 is an enlarged-perspective view illustrating a bushing and a bushing cover that are installed on an upper surface of a movable seal cup constituting the embodiment of the present disclosure.

FIG. 4 is an enlarged-sectional view illustrating the bushing and the bushing cover that are installed on the upper portion of the movable seal cup constituting the embodiment of the present disclosure.

FIG. 5 is a sectional view illustrating a bellows in the contraction state constituting the embodiment of the present disclosure.

FIG. 6 is a sectional view illustrating the bellows in the expansion state constituting the embodiment of the present disclosure.

FIG. 7 is an enlarged-sectional view illustrating a portion of a sleeve received in a sleeve-receiving part constituting the embodiment of the present disclosure.

FIG. 8 is an enlarged-sectional view illustrating the sleeve-receiving part coupled to an end of the bellows constituting the embodiment of the present disclosure.

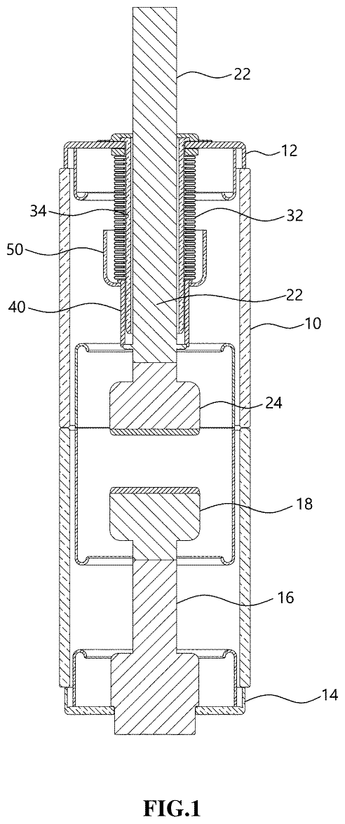

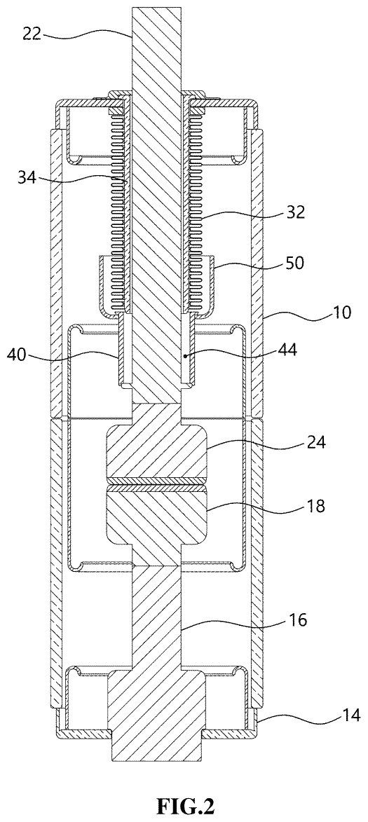

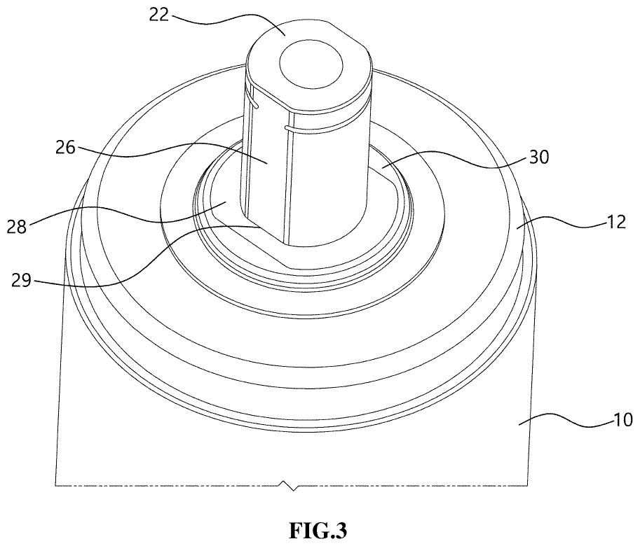

### Mode for Invention

Hereinbelow, exemplary embodiments of the present disclosure will be described in detail with reference to accompanying drawings. As for reference numerals associated with parts in the drawings, wherever possible, the same reference numerals will be used throughout the drawings and the description to refer to the same or like elements or parts. Furthermore, in describing the embodiment of the present disclosure, when detailed description of the known functions and configuration related with the present disclosure may make the gist of the present disclosure unclear, a detailed description thereof will be omitted.

Further, when describing the components of the present disclosure, terms such as first, second, A, B, (a), or (b) may be used. Since these terms are provided merely for the purpose of distinguishing the components from each other, they do not limit the nature, sequence or order of the components. It will be understood that when an element is referred to as being “coupled” or “connected” to another element, it can be directly coupled or connected to the other element or intervening elements may be present therebetween.

Hereinbelow, the configuration of a vacuum interrupter of an embodiment of the present disclosure will be described with reference to accompanying drawings.

As illustrated in the drawings, the vacuum interrupter of the present disclosure is made of an insulating material and includes a container (10) having a vacuum therein, a movable seal cup (12) coupled to a first end of the container (10), having a movable rod through hole (20) on a central portion, and closing a first side of the container (10), a fixed seal cup (14) coupled to a second end of the container (10) and closing a second side of a second portion of the container, a movable rod (22) inserted into the movable rod through hole (20), installed to be movable vertically, and having a movable contact point (24) at an end portion, a fixed rod (16) installed through the fixed seal cup (14) and having a fixed contact point (18) at an end portion, a bellows (32) shaped in a corrugated tube, installed to cover an outer circumferential surface of the movable rod (22), and configured to contract and expand according to vertical movement of the movable rod (22), a sleeve (34) having a tube shape, installed between the bellows (32) and the movable rod (22), and guiding the contraction and the expansion of the bellows (32), and a sleeve-receiving part (40) installed at a lower portion of the movable rod, having a sleeve-receiving space (44) therein, and receiving a part of the sleeve (34) when the movable rod (22) performs opening movement.

The container (10) is made of an insulating material and has a hollow cylindrical shape. The material of the container (10) is generally ceramic which is an insulating material. In addition to ceramic material, various insulating materials may be applied. The fixed rod (16) and the movable rod (22) to be described below are installed inside the container (10), and the inside space of container (10) is a portion to be opened and closed.

The movable seal cup (12) and the fixed seal cup (14) are respectively installed at a first portion and a second portion of the container (10). The movable seal cup (12) and the fixed seal cup (14) have cup shapes and are installed to cover the first opening portion and the second opening portion of the container (10).

The movable seal cup (12) and the fixed seal cup (14) close the first opening portion and the second opening portion of the container (10) to completely shield the container (10) so that the inside space of the container (10) has a vacuum.

The fixed rod (16) is installed through the fixed seal cup (14). The fixed rod (16) is a normal fixed rod, and a detailed description will be omitted. The fixed rod (16) has a rod shape and is formed to be long in one direction, and a first end portion thereof has the fixed contact point (18) having a disc shape. The fixed rod (16) is made of a conductive material. The fixed rod (16) is a portion where the movable contact point (24) to be described below is brought into contact with and separated from the fixed contact point (18) according to the movement of the movable rod (22) to be described below.

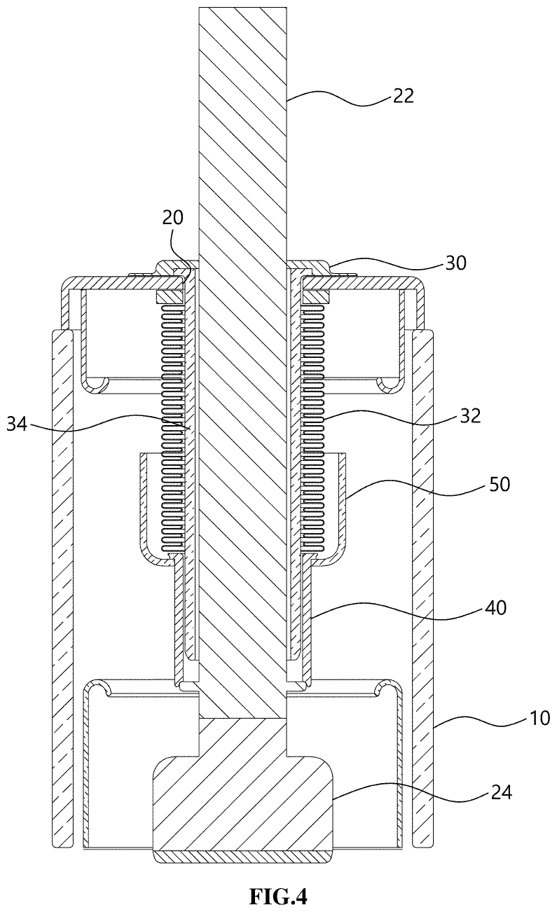

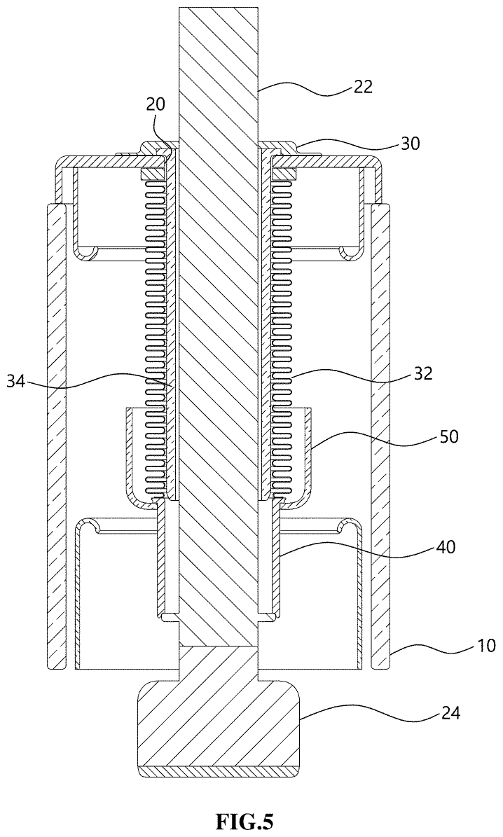

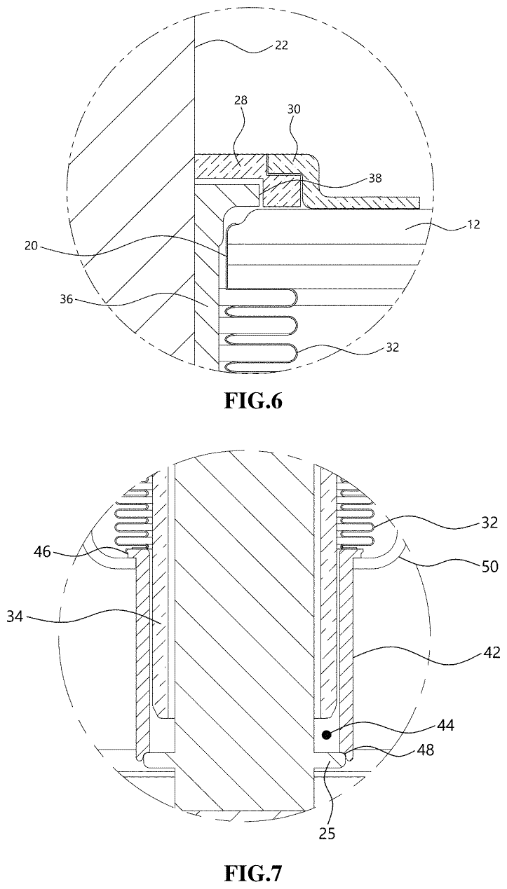

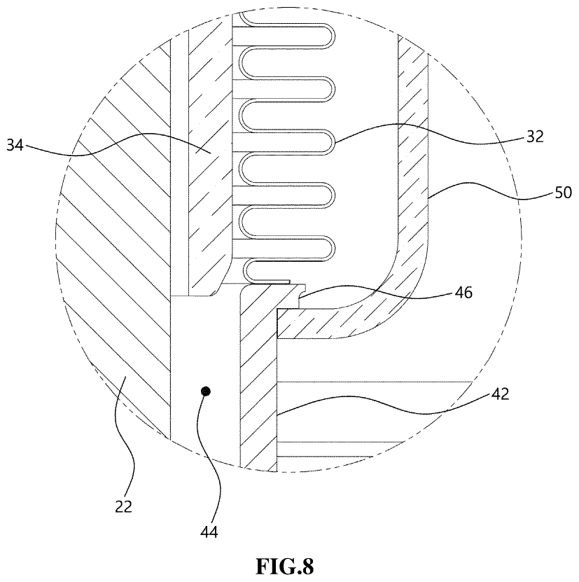

As illustrated in FIG. 4, the movable rod through hole (20) is formed in a central portion of the movable seal cup (12). The movable rod through hole (20) has a shape corresponding to a cross-section of the movable rod (22) to be described below, and is formed through the central portion of the movable seal cup (12).

The movable rod through hole (20) is provided for the movable rod (22) to be described below to be movably installed through the inside space thereof.

The movable rod (22) is installed inside the movable rod through hole (20). The movable rod (22) is a normal movable rod, and a detailed description will be omitted. The movable rod (22) has a rod shape, is formed to be long in one direction, and has the movable contact point (24) at a first end portion thereof. The movable rod (22) is made of a conductive material, and preferably, may be made of oxygen-free copper. The movable rod (22) is installed to be vertically movable based on the drawing by an operating part (not illustrated) or a driving part (not illustrated).

According to the vertical movement of the movable rod (22), the movable contact point (24) having a disc shape is moved at a lower end of the movable rod (22). Therefore, the closing movement in which the movable contact point (24) is brought into contact with the fixed contact point (18) or the opening movement in which the movable contact point (24) is separated from the fixed contact point (18) to be described below may be performed.

In other words, when the movable contact point (24) is in contact with the fixed contact point (18), current may flow from a power supply and be transmitted to a load side. When the movable contact point (24) is separated from the fixed contact point (18), the current transmitted from the power supply to the load side may be blocked.

A flat part (26) is formed at a side surface of the movable rod (22). The flat part (26) is formed on each side surface of an upper portion of the movable rod (22), and it is possible to prevent the movable rod (22) from being rotated according to insertion into the movable rod through hole (20).

A bushing (28) is installed on an outer surface of the movable seal cup (12). The bushing (28) is a normal bushing, and a detailed description will be omitted. A movable rod mounting hole (29) is formed in a central portion of the bushing (28) and provided for the movable rod (22) to be installed therethrough, and the bushing (28) serves to guide the movement of the movable rod (22).

A bushing cover (30) is installed on an upper surface of the bushing (28). As illustrated in FIG. 4, the bushing cover (30) is installed to cover the bushing (28) along an edge of the bushing (28) and fixes the bushing (28) at a central portion of an outer surface of the movable seal cup (12).

Furthermore, an outer edge portion of the bushing cover (30) is welded, and the bushing cover (30) may be firmly fixed to the outer surface of the movable seal cup (12).

The bellows (32) is installed inside the container (10). The bellows (32) has a retractile corrugated tube shape and is installed to cover an outer circumferential surface of the movable rod (22). A first end portion of the bellows (32) is fixed to an inner surface of the movable seal cup (12), and a second end portion thereof is fixed to the sleeve-receiving part (40) to be described below. The bellows (32) contracts and expands according to the movement of the movable rod (22) and is configured to shield the movable rod (22).

In other words, even when the movable rod (22) is vertically moved inside the container (10) on the basis of the drawing, as the bellows (32) is installed to cover the outer circumferential surface of the movable rod (22), the movable rod (22) may be moved while the vacuum state of the container (10) is maintained.

The sleeve (34) is installed between the movable rod (22) and the bellows (32). The sleeve (34) consists of a sleeve body (36), a sleeve fixing end (38), etc.

The sleeve body (36) has a tube shape formed to be long in one direction and is installed to cover the movable rod (22). The sleeve body (36) is installed with a length corresponding to an expansion length of the bellows (32) along a circumferential surface of the movable rod (22). The sleeve body (36) is installed between the bellows (32) and the movable rod (22) and prevents the bellows (32) from buckling during the contraction and expansion of the bellows (32), and guides movement of the movable rod (22) and the contraction and expansion of the bellows (32).

The sleeve fixing end (38) is formed at one end of the sleeve body (36). Based on the drawing, the sleeve fixing end (38) is formed to protrude horizontally along an upper end portion of the sleeve body (36). The sleeve fixing end (38) is securely installed at one portion of the movable seal cup (12) in a welding method, and the sleeve body (36) may be fixed to the inside portion the container (10).

Furthermore, as the sleeve body (36) is installed with a length corresponding to an expansion length of the bellows (32), the sleeve body (36) guides the whole operational section of the bellows (32), and buckling of the bellows (32) may be prevented within the whole operational section of the bellows (32).

The sleeve-receiving part (40) is installed at a second end portion of the bellows (32). The sleeve-receiving part (40) consists of a sleeve-receiving body (42), a bellows-fixing end (46), a movable rod-fixing groove (48), etc.

Based on the drawing, the sleeve-receiving body (42) has a hollow cylindrical shape with upper and lower open end portions and is installed to be spaced apart from the outer circumferential surface of the movable rod (22) at a predetermined interval. The sleeve-receiving space (44) is formed between the sleeve-receiving body (42) and the movable rod (22). When the movable rod (22) contracts, as illustrated in FIG. 4, a lower side portion of the sleeve (34) may be received in the sleeve-receiving space (44).

The bellows-fixing end (46) is formed at a first end of the sleeve-receiving body (42). The bellows-fixing end (46) is formed to be bent along the first end portion of the sleeve-receiving body (42) in a centrifugal direction. An upper surface of the bellows-fixing end (46) based on the drawing is welded to an end of the bellows (32), a lower surface based on the drawing, and the sleeve-receiving part (40) may be firmly fixed to the bellows (32).

The movable rod-fixing groove (48) is formed at a second end of the sleeve-receiving body (42). The movable rod-fixing groove (48) is formed to be recessed in an arc shape along an inner circumferential portion of the second end of the sleeve-receiving body (42). A fixed rib (25) is formed to protrude on a second side of the movable rod (22) and coupled to an inside portion of the movable rod-fixing groove (48). The fixed rib (25) of the movable rod (22) is welded while being coupled to the movable rod-fixing groove (48), and the sleeve-receiving part (40) may be firmly fixed to the movable rod (22).

In other words, as the first end portion of the sleeve-receiving part (40) is fixed to the second end portion of the bellows (32) and the second end portion thereof is fixed to the movable rod (22), the bellows (32) may contract and expand when the movable rod (22) performs the opening movement and closing movement.

Specifically, when the movable rod (22) performs the opening movement, the bellows (32) contracts due to the upward movement of the movable rod (22), and the second end portion of the sleeve (34) installed between the movable rod (22) and the bellows (32) may be located in the sleeve-receiving space (44) of the sleeve-receiving part (40).

A bellows protection shield (50) is installed at a lower surface of the bellows-fixing end (46) based on the drawing. The bellows protection shield (50) has a cup shape, and is arranged to be spaced apart from the outer circumferential surface of the bellows (32) at a predetermined interval. A lower portion of the bellows protection shield (50) is welded to the lower surface of the bellows-fixing end (46) and firmly fixed to the sleeve-receiving part (40). The bellows protection shield (50) is provided to receive the lower portion of the bellows (32) to prevent the bellows (32) from being damaged due to arc generated in the container (10).

As described above, the vacuum interrupter according to the present disclosure has the sleeve-receiving part (40) installed at one portion of the movable rod (22) so that a portion of the sleeve (34), which prevents buckling of the bellows (32), may be received in the sleeve-receiving space (44) inside the container (10) when the movable rod (22) performs the opening movement.

Therefore, when the bellows (32) contracts, the second end portion of the sleeve (34) is received in the sleeve-receiving part (40), and there is an advantage of securing the space for the sleeve (34) to be arranged inside the container (10) without the need to expose the sleeve (34) outward of the container (10).

Furthermore, since the sleeve is operated inside the container (10) without the need for outward exposure of the sleeve (34) preventing buckling of the bellows (32), design changes and additional components to secure power lines can be minimized, so the manufacturing period can be shortened and manufacturing costs can be reduced.

Furthermore, since the sleeve (34) guides the whole operational section of the bellows (32), the sleeve (34) can support and guide the entire corrugations of the bellows (32), so it is possible to fundamentally prevent the reduction in lifespan due to buckling of the bellows (32).

Hereinabove, even though all components constituting the embodiment according to the present disclosure have been described as being combined or operated in combination as one, the present disclosure is not necessarily limited to the embodiment. In other words, within the scope of the purpose of the present disclosure, one or more parts of all the parts may be selectively coupled to each other to be operated. Furthermore, it will be further understood that the terms “include”, “comprise” “have”, etc. described in this specification, should be interpreted as having the presence of the components unless the context clearly indicates otherwise, but other components are not excluded, and are further included. Unless otherwise defined, all terms which include technical and scientific terms, used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the preferred embodiments of the present disclosure have been described for illustrative purposes, those skilled in the art will appreciate that various modifications, additions and substitutions are possible, without departing from the scope and spirit of the present disclosure as disclosed in the accompanying claims. Therefore, the preferred embodiments described above have been described for illustrative purposes, and should not be intended to limit the technical spirit of the present disclosure, and the scope and spirit of the present disclosure are not limited to the embodiments. The protective scope of the present disclosure should be interpreted by the accompanying claims, and all technical spirits within the equivalent scope should be interpreted as being included in the scope and spirit of the present disclosure.

As illustrated in the embodiment, an end of the sleeve-receiving part (40) is fixed to the fixed rib (25) of the movable rod (22). However, the end of the sleeve-receiving part (40) may be directly fixed to the outer surface of the second end of the movable rod (22).

Furthermore, as illustrated in the embodiment, the bellows protection shield (50) receives the lower portion of the bellows (32) based on the drawings, and damages to the bellows (32) due to arc generated in the container (10) is prevented. However, the bellows protection shield (50) is installed to expand to not only the lower portion of the bellows (32) but also the upper portion of the bellows (32) based on the drawing, so it is possible to prevent damage to the whole section of the bellows (32) due to generation of arc.

1. A vacuum interrupter comprising:
a container made of an insulating material, and having a vacuum therein;
a movable seal cup coupled to a first end of the container, having a movable rod through hole on a central portion, and closing a first side of the container;
a fixed seal cup coupled to a second end of the container and closing a second side of the container;
a movable rod inserted into the movable rod through hole to be movably installed and having a movable contact point at an end portion thereof;
a fixed rod provided through the fixed seal cup and having a fixed contact point at an end portion thereof;
a bellows shaped in a corrugated tube, provided to cover an external circumferential surface of the movable rod, and configured to contract and expand in response to movement of the movable rod;
a sleeve having a tube shape, provided between the bellows and the movable rod, and guiding the contraction and expansion of the bellows; and
a sleeve-receiving part installed at a second end of the movable rod, having a sleeve-receiving space therein, and receiving a portion of the sleeve when the movable rod performs opening movement.

2. The vacuum interrupter of claim 1, wherein the sleeve-receiving part has a diameter greater than a diameter of the movable rod, has a tube shape, and has a first end fixed to an end of the bellows and a second end fixed to the second end portion of the movable rod.

3. The vacuum interrupter of claim 1, wherein the sleeve comprises:
a sleeve body having a tube shape, provided to cover the movable rod, and having a length corresponding to an expansion length of the bellows; and
a sleeve fixing end formed by being bent at an end portion of the sleeve body and fixing the sleeve body to the movable seal cup.

4. The vacuum interrupter of claim 2, further comprising:
a bushing provided at a coupling portion between the sleeve fixing end and the movable seal cup, having a movable rod mounting hole on an outer surface to guide movement of the movable rod, and preventing friction between the movable rod and the movable seal cup.

5. The vacuum interrupter of claim 4, further comprising:
a bushing cover provided at an outer surface of the bushing to cover the bushing along an edge of the bushing and fixing the bushing to the movable seal cup.

6. The vacuum interrupter of claim 1, further comprising:
a bellows protection shield provided at a second end of the bellows, having a cup shape, disposed to be spaced apart from the bellows at a predetermined interval along an outer circumferential surface of the bellows, and preventing damage to the bellows due to arc generated inside the container.
